(19) United States
(12) Patent Application Publication
(10) Pub. No.: US 2026/0270301 A1
(43) Pub. Date: Sep. 10, 2026

(54) Methods and Apparatuses for Determining and Selecting Internet Protocol Multimedia Subsystem, IMS, Media Functions in a Wireless Communications Network

(71) Applicant: Telefonaktiebolaget LM Ericsson (publ), Stockholm (SE)

(72) Inventors: Afshin Abtin, Sollentuna (SE); Håkan Österlund, Ekerö (SE); Mattias Dahlqvist, Stockholm (SE); Charles Hegarty, Stockholm (SE); Sorin Surdila, Laval (CA)

(21) Appl. No.: 19/160,803

(22) PCT Filed: Apr. 20, 2023
(86) PCT No.: PCT/SE2023/050363

§ 371 Date: Aug. 28, 2025

(51) Int. Cl. H04L 65/1016; H04L 65/1073

(52) U.S. Cl. CPC H04L 65/1016; H04L 65/1073

(57) ABSTRACT

A method performed by an Internet Protocol Multimedia Subsystem, IMS, control node is provided. The method is for selecting IMS media functions associated to an IMS call session for a User Equipment, UE, in a wireless communications network. E.g., during IMS registration for the UE, the IMS control node requests (501) and obtains (502) from a first Core Network, CN, node information about a User Plane Function, UPF, node and its geographical location, which UPF node is serving the UE. The IMS control node further requests (503) and obtains (504) from a second CN node, IMS media function candidates operating at distances closest to the geographical location of the UPF node. The IMS control node then selects (505) for the IMS call session, IMS media functions among the IMS media function candidates, based on their respective distance to the geographical location of the selected UPF node.

### TECHNICAL FIELD

Embodiments herein relate to an Internet Protocol Multimedia Subsystem (IMS) control node, a core network node, and a methods therein. In some aspects, they relate to selecting IMS media functions associated to an IMS call session for a User Equipment (UE) in the wireless communications network. In some other aspects, they relate to determining IMS media function candidates to an IMS call session for the UE, UE, (120) in the wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5G Core (5GC) is core network, NR is radio access network. As a continued network evolution, the new release of 3GPP specifies a 5G network also referred to as 5G New Radio (NR) and 5GC.

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

3GPP starting in Release 15 has specified 5G Core and architecture principles for Voice over NR. FIG. 1 depicts a general 5GC architecture with its interfaces N# as specified by 3GPP TS 23.501, wherein:
NSSAAF means Network Slice-Specific
SNSPN Authentication and Authorization Function,
NSSF means Network Slicing Selection Function,
AUSF means Authentication Server Function,
UDM means Unified Data Management.
NSACF means Network Slice Admission Control Function,
AMF means Access and Mobility management Function,
SMF means System Management Facility,
PCF means Policy Control Function,
AF means Application Function,
UPF means User Plane Function,
DN means Data Network.

The architecture for existing Voice in 5GS is based on the diagram depicted in FIG. 2, wherein:
MME means Mobility Management Entity,
HSS means Home Subscriber Server,
SGW means Serving Gateway,
SMF means Session Management Function,
EPS means Evolved Packet System.

Internal details of an Internet Protocol Multimedia Subsystem (IMS) architecture are specified in 3GPP TS 23.228.

Further, 3GPP Release 16 specifies how IMS Network Functions (NFs) can utilize 5GC Network Repository Function (NRF) for interaction with 5GC but this has been limited to few NFs and for interactions between IMS Application Server (AS)/Call Session Control Function (CSCF) and Home Subscriber Server (HSS), and between Proxy-Call Session Control Function (P-CSCF) and Policy Control Function (PCF).

In 3GPP Release 16 and 17 AR use cases have been analysed, where several use cases are conversational AR, meaning that they imply that two or more parties are involved in the AR session.

3GPP Release 18, System Aspects (SA)2 and SA4 are specifying realization of conversational AR use cases where one of the options are based on IMS. See FIG. 3, which depicts current and ongoing architecture of IMS extended with IMS Data Channel and enhancements for AR Telephony wherein:
ISC is a reference point between a CSCF and an Application Server,
I/S-CSCF means Interrogating/Serving Call Session Control Function
IMS AGW means IMS Access Gateway,
DCMF means Data Channel Media Function,
ARMF means Augmented Reality Media Function
DCSF means Data Channel Signaling Function,
MDC# are reference points for Data Channel Media,
DC# are reference points for IMS Data channel (signaling).
Mb is a reference point used for IMS media transport to IP network services,
Gm is a reference point between a UE and a P-CSCF,
Iq is a reference point between P-CSCF and IMS AGW.

Reference points Gm and Mb from a UE to IMS will be via User Plane Function (UPF), 3GPP TS 23.501, 3GPP TS 23.502, over an IMS Protocol Data Unit (PDU) session.

Examples of AR telephony use cases e.g., comprise, but are not limited to remote assistance and avatar.
Remote assistance is an expert and support assistance serving a subscriber with deeper technical assistance remotely using audio, video and AR as technology to improve the experience.
Avatar relates to a two-party session, where one end of the session uses its avatar to be projected on the other side's glasses and/or phone and the avatar is placed into the environment of the user and captures the avatar users face expressions and render it on the avatar's face.

According to 3GPP TR 26.998, there are different AR device types, where some are capable of processing necessary AR related functions locally on the device while others may depend on network processing of AR. Reasons for network processing may be to reduce battery consumption in the device or simply due to lower capabilities of the device. This is here referred to offload to the network.

As some AR processing for some use cases are rather latency sensitive. Such use case is, e.g., pose to render to photon, 3GPP TR 26.928. This may be a processing of a head movement until a scene is rendered and presented on the AR device. Such processing benefits from being placed closer to a UE to reduce the latency contribution of the distance.

Today's 4G and 5G networks are deployed to enable good user experience for Mobile Broadband (MBB) service and optimized for voice user experience such as e.g. Voice over LTE (VoLTE) and/or Voice over NR (VoNR). This is for example to enable a mouth to ear latency of 225 ms to achieve good voice Key Performance Indicators (KPI)s. Some aspects of AR processing may require much lower latency e.g., 40-60 ms.
For voice over EPS (VoLTE) or 5GS (VoNR), the budget for the distance has been calculated to about 25 ms which approximately gives 1000 Km from Radio site to IMS media plane while processing in the RAN, UPF and IMS Media Functions is budgeted for 12-14 ms, e.g. for RAN, UPF, and/or IMS media functions.

However, the problem is that the latency often exceeds the budget.

### SUMMARY

An object of embodiments herein is to improve latency when using IMS media functions in a wireless communications network.

According to an aspect of embodiments herein, the object is achieved by a method performed by an Internet Protocol Multimedia Subsystem, IMS, control node. The method is for selecting IMS media functions associated to an IMS call session for a User Equipment, UE, in a wireless communications network. E.g., during IMS registration for the UE, the IMS control node requests (501) and obtains (502) from a first Core Network, CN, node information about a User Plane Function, UPF, node and its geographical location, which UPF node is serving the UE. The IMS control node further requests (503) and obtains (504) from a second CN node, IMS media function candidates operating at distances closest to the geographical location of the UPF node. The IMS control node then selects (505) for the IMS call session, IMS media functions among the IMS media function candidates, based on their respective distance to the geographical location of the selected UPF node.

According to an aspect of embodiments herein, the object is achieved by a method performed by a second Core Network, CN, node. The method is for determining Internet Protocol Multimedia Subsystem, IMS, media function candidates to an IMS call session for a User Equipment, UE, in a wireless communications network. The CN node obtains correlations. The correlations relate to geographical locations between the IMS media functions and UPF nodes, regarding their mutual distances. The CN node receives information and a request from an IMS control node. The information is about a User Plane Function, UPF, node, and its geographical location. The UPF node is serving the UE. The which request requests for IMS media function candidates operating at distances closest to the geographical location of the UPF node. The CN node determines IMS media function candidates according to the request, based on the obtained correlations and the received information, and sends the determined IMS media function candidates to the IMS control node.

According to another aspect of embodiments herein, the object is achieved by an Internet Protocol Multimedia Subsystem, IMS, control node. The IMS control node is configured to select IMS media functions associated to an IMS call session for a User Equipment, UE, in a wireless communications network. The IMS control node is further configured to:
E.g., during IMS registration for the UE, request and obtain from a first Core Network, CN, node information about a User Plane Function, UPF, node and its geographical location, which UPF node is adapted to serve the UE,
request and obtain from a second CN node, IMS media function candidates operating at distances closest to the geographical location of the UPF node, and
select for the IMS call session, IMS media functions among the IMS media function candidates, based on their respective distance to the geographical location of the selected UPF node.

According to an aspect of embodiments herein, the object is achieved by a second Core Network, CN, node. The second CN node is configured to determine Internet Protocol Multimedia Subsystem, IMS, media function candidates to an IMS call session for a User Equipment, UE, in a wireless communications network. The second CN node further is configured to:
Obtain correlations, which correlations are adapted to relate to geographical locations between the IMS media functions and UPF nodes, regarding their mutual distances,
receive information and a request from an IMS control node, which information is adapted to be about a User Plane Function, UPF, node, and its geographical location, which UPF node is serving the UE, and which request is adapted to request IMS media function candidates operating at distances closest to the geographical location of the UPF node,
determine IMS media function candidates according to the request, based on the obtained correlations and the received information, and
send the determined IMS media function candidates to the IMS control node.

Thanks to that the IMS media functions for the IMS call session are selected among IMS media function candidates, based on their respective distance to the geographical location of the selected UPF node, the latency contribution related to the distance between the UPF node, and the IMS media functions is reduced and the UE experience in e.g., AR sessions is improved that would otherwise need to be offloaded to network for processing.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic block diagram illustrating prior art.

FIG. 4 is a schematic block diagram illustrating embodiments of a wireless communications network.

FIG. 5 is a flowchart depicting an embodiment of a method in an IMS control node.

FIG. 6 is a flowchart depicting an embodiment of a method in a second CN node.

FIG. 7 is a sequence diagram illustrating an example embodiment of a method herein.

FIG. 8 is a schematic block diagram illustrating an example scenario of embodiments herein.

FIG. 9 is a schematic block diagram illustrating embodiments of an IMS control node.

FIG. 10 is a schematic block diagram illustrating embodiments of a second CN node.

FIG. 11 schematically illustrates embodiments of a communication system.

FIG. 12 is a generalized block diagram of embodiments of a UE.

FIG. 13 is a generalized block diagram of embodiments of a network node.

FIG. 14 is a generalized block diagram of embodiments of a host.

FIG. 15 is a generalized block diagram of embodiments of a virtualization environment.

FIG. 16 is a generalized block diagram of embodiments of a communication diagram of a host.

### DETAILED DESCRIPTION

Examples of embodiments provide principles and procedures for how to enable allocation of IMS media functions close to UPF, thereby lowering the distance and improve the latency and user experience.

Examples of embodiments herein may e.g., be implemented in the IMS architecture serving AR telephony as being specified in 3GPP R18, SA2, TR 23.700-87 as mentioned above.

Example embodiments herein provide an IMS control node, such as e.g., an IMS control plane, to allocate IMS media functions close to an UPF node. Locating Packet Core, such as the UPF node and IMS media resources, serving an IMS PDU session, close to each other will shorten the media path and thereby reduce latency. This will give additional budget for AR processing in the wireless communications network.

According to example embodiments herein, this may be performed by informing the IMS control node about the geographical location such as e.g. site, or the selected UPF node for the IMS PDU session, also referred to as Product Data Until for IMS connectivity between UE and network for connectivity service. The IMS control node may further use this information to, via NRF, select IMS media plane NFs close or in same site as the selected UPF node. As the geographical locations, e.g. sites, of UPF nodes and IMS NFs may not be aligned and to avoid configuration of which sites and geo-areas are close to each other, the NRF may also hold a mapping table to have such information in relation the UPF node sites/site names and IMS user plane sites and site names.

As mentioned above, example embodiments herein enable selection of IMS NFs close to UPF sites and reduces the contribution of the distance and improves the UE experience e.g., in AR sessions that would otherwise need to be offloaded to network for processing. Further example embodiments herein avoid complicated configuration on multiple IMS NFs of cell-ids, IP addresses and IP address ranges, site, and geographical locations data and on individual NFs.

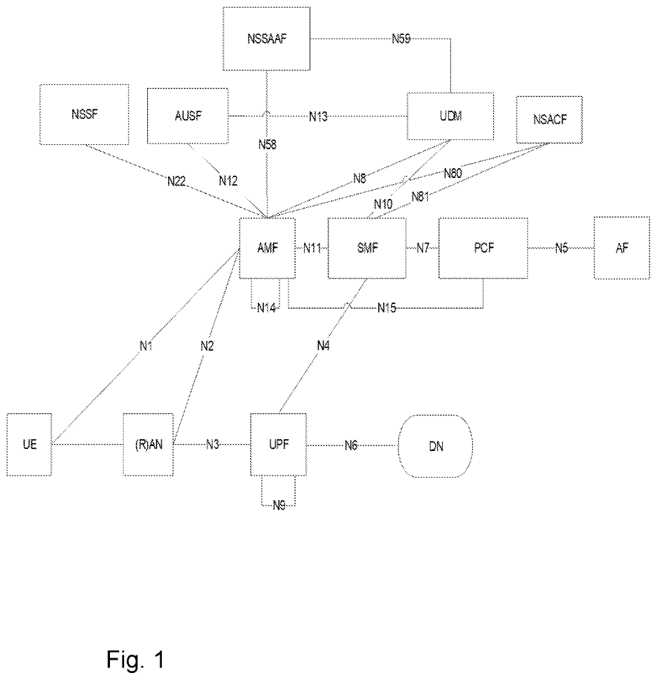

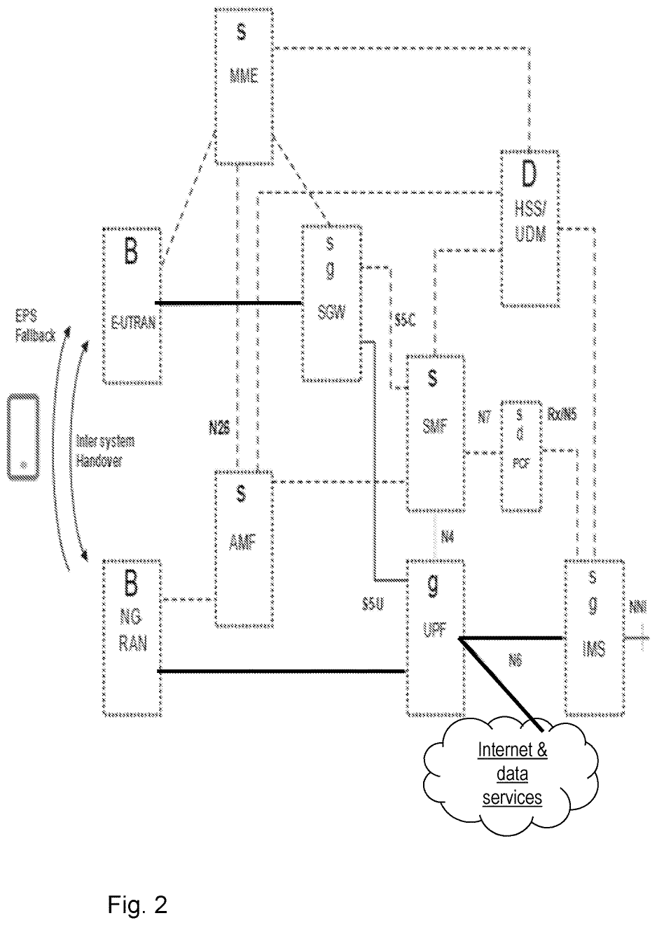

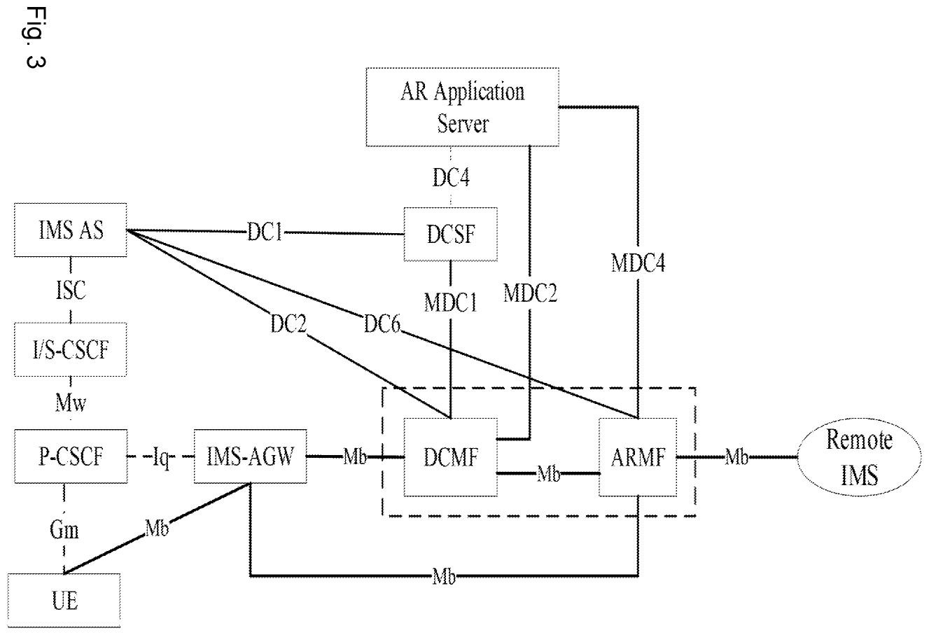

FIG. 1 is a schematic overview depicting a wireless communications network 100 wherein embodiments herein may be implemented. The communications network 100 comprises one or more RANs, one or more CNs and an IMS network 105. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Base stations such as the base station 110 operate in the RAN the wireless communications network 100. The base station 101 provides one or more cells such as a first cell 11. The base station 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs, such as a UE 120, within the first cell 11, served by the base station 110. The base station 110 may be referred to as a serving radio network node and communicates with the UE 120 with Downlink (DL) transmissions to the UE 120 and Uplink (UL) transmissions from the UE 120.

The communications network 100 further comprises the IMS network 105, in which an IMS control node 130 operates. According to embodiments herein the IMS node 110 may be or may comprise any one or more out of a P-CSCF, node, a S-CSCF, node, and an IMS AS node. The IMS network 105 is an architecture for delivering media content over an IP packet switched transport.

UPF nodes operate in the communication network 100, such as e.g., an UPF node 140. The UPF nodes are central elements in the CN. It is a primary network function of the 5G CN for User Plane and plays an important role in data transfer.

The communications network 100 further comprises a Core Network (CN), in which CN nodes such as e.g., a first CN node 151 and as second CN node 152 operate. According to embodiments herein the first CN node 151 may be or may comprise and System Management Facility (SNF) node and the second CN node 152 may be or may comprise a Network Repository Function (NRF) node.

One or more UEs operate in the communication network 100, such as e.g. the UE 120 and a second UE 122. Each UE 120, 122 may e.g. be 5G-RG, an a 5G device, such as e.g. the UE 120, that is enhanced with AR capability, a remote UE, a wireless device, an NR device, a mobile station, a wireless terminal, an NB-IOT device, an MTC device, an eMTC device, a CAT-M device, a WiFi device, an LTE device and an a non-access point (non-AP) STA, a STA, that communicates via a base station such as e.g. a base station 105, one or more Access Networks (AN), e.g. a RAN, to one or more core network (CN) nodes, in one or more CNs, one or more IMS nodes, such as e.g. the IMS control node 130 in the IMS network 105. The UEs 120, 122 may communicate with one or more CN nodes such as the first CN node 151 and second CN node 152, or IMS nodes, such as the IMS control node 130. It should be understood by the skilled in the art that “UE” is a non-limiting term which means any terminal, client, mobile client, IMS client, wireless communication terminal, user equipment, Device to Device (D2D) terminal, or node e.g. smart phone, laptop, mobile phone, sensor, relay, mobile tablets or even a car or any small base station communicating within a cell.

The IMS network 105 further comprises IMS media functions 160 such as e.g., any one or more out of an Access Gateway (AGW), a Data Channel Media Function (DCMF), and an Augmented Reality Media Function (ARMF).

Subscriber data nodes (not shown) may operate in the wireless communications network 100. The subscriber data nodes may e.g. operate in the IMS network 105, the CN, or be connected to said IMS network 105 or CN. The subscriber data nodes stores and manages subscriber data related to UEs, such as e.g. the UE 120. According to embodiments herein a subscriber data nodes may be a Home Subscriber Server (HSS) or a Policy Control Function (PCF) node.

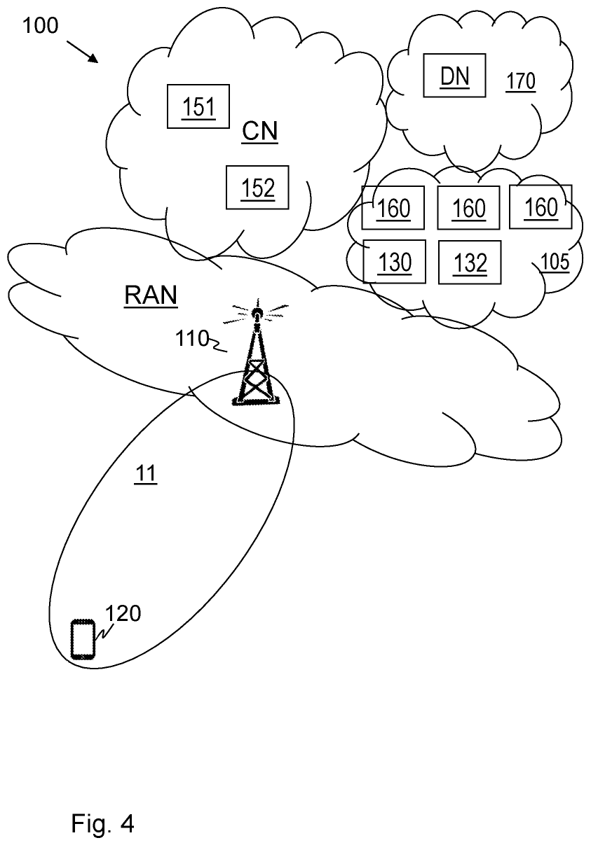

Methods according to embodiments herein are performed by the IMS control node 130, and the second CN node 152. These nodes may be Distributed Nodes (DN)s and functionality, e.g. comprised in a cloud 170 as shown in FIG. 4.

A number of embodiments will now be described, some of which may be seen as alternatives, while some may be used in combination.

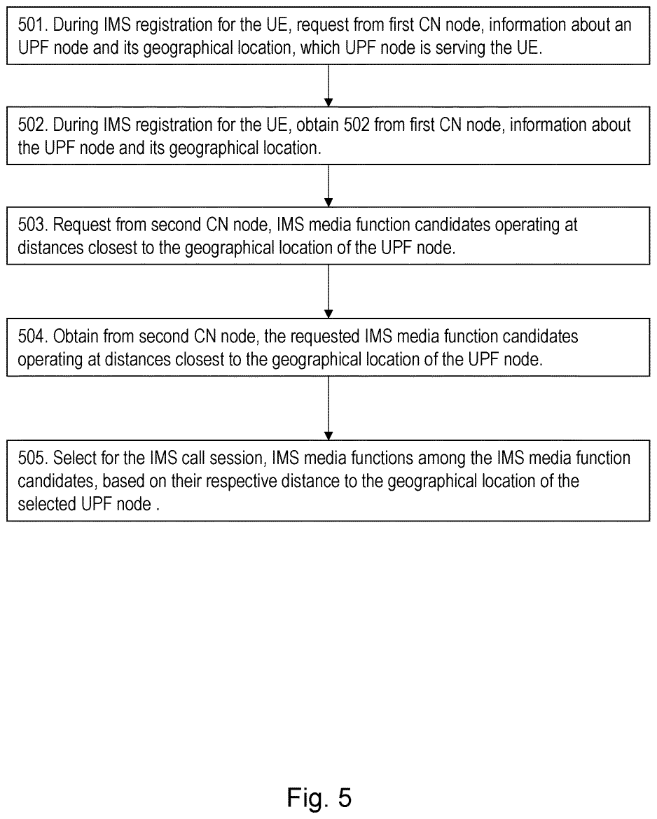

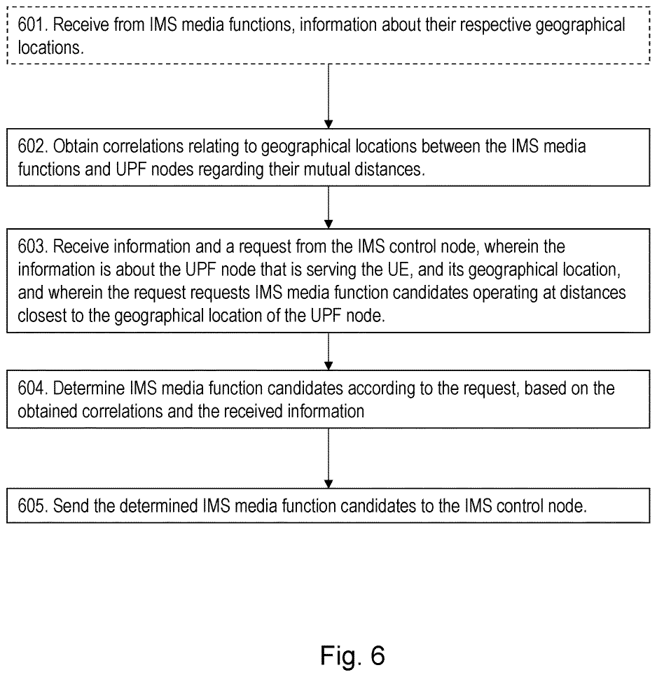

A method according to embodiments will first be described as seen from the view of the IMS control node 130 together with FIG. 5, and then as seen from the view of the second CN node 152 together with FIG. 6.

FIG. 5 shows exemplary embodiments of a method performed by the IMS control node 130. The IMS control node 130 may e.g., comprise any one or more out of an S-CSCF node, a P-CSCF, and an IMS AS node. The method is for selecting IMS media functions 160, such as e.g., AGW, DCMF, ARMF, associated to an IMS call session for the UE 120 in the wireless communications network 100.

The first CN node 151 may be represented by an SMF node, and the second CN node 152 may be represented by an NRF node.

The method comprises the following actions, which actions may be taken in any suitable order.

According to an example scenario the UE 120 is about to set up an IMS call session e.g. for AR telephony for sending and/or receiving IMS media, such as e.g., any one or more out of audio, video and AR media. Or as an alternative update of the IMS call session with new IMS media.

Action 501. This action is performed during IMS registration for the UE 120. The IMS control node 130 requests from the first CN node 151, information about the UPF node 140 and its geographical location. The information about the geographical location may e.g., comprise a site id of the site where the UPF node 140 is located or and UPF id where the geographical location of the UPF is encoded into the UPF id or similar. The UPF node 140 serves the UE 120.

According to the example scenario, the IMS control node 130 need to find IMS media functions close to the UPF node 140, to lowering the distance between the UPF node 140 and the IMS media functions, and thereby improve the latency and UE 120 user experience. E.g., to start with, the IMS control node 130 need the information about the geographical location of the UPF node 140.

In some embodiments, the IMS control node 130 is represented by a P-CSCF node and the first CN node 151 is represented by an SMF node. In these embodiments, the requesting of the information from the first CN node 151 comprises requesting said information about the geographical location of the UPF node 140 from the SMF node via the PCF node.

In some alternative embodiments, the IMS control node 130 is represented by an S-CSCF node and the first CN node 151 is represented by an SNF node. In these alternative embodiments, the requesting of the information from the first CN node 151 comprises requesting said information about the geographical location of the UPF node 140 from the SMF node via the HSS node.

Action 502. Also, this action is performed during the IMS registration for the UE 120. The IMS control node 130 further obtains 502 from the first CN node 151 the requested information about the UPF node 140 and its geographical location.

In some embodiments as mentioned above, the IMS control node 130 is represented by a P-CSCF node and the first CN node 151 is represented by an SMF node. In these embodiments, the obtaining if the information from the first CN node 151 comprises obtaining said information about the geographical location of the UPF node 140 from the SMF node via the PCF node.

In some of the alternative embodiments as mentioned above, the IMS control node 130 is represented by the S-CSCF node and the first CN node 151 is represented by the SNF node. In these alternative embodiments, the obtaining of the information from the first CN node 151 comprises obtaining said requested information about the geographical location of the UPF node 140 from the SMF node via the HSS node.

Action 503. This action may be performed during IMS call session set up for the UE 120 or later during update of the session with new IMS media. The IMS control node 130 requests IMS media function candidates from the second CN node 152, e.g. an NRF node. The requested IMS media function candidates shall be operating at distances closest to the geographical location of the UPF node 140.

According to the example scenario, when the IMS control node 130 has got information about the geographical location of the UPF node 140, it needs to find IMS media functions that are close to the geographical location of the UPF node 140. The second CN node 152 has knowledge about the geographical location of different IMS media functions. The IMS control node 130 informs the second CN node 152 about the geographical location of the UPF node 140 and asks for, also referred to as requests the second CN node 152 for the IMS media function candidates with a geographical location that are closest to the UPF node 140.

Action 504. Also, this action may be performed during IMS call session set up for the UE 120 or later during update of the session with new IMS media. The IMS control node 130 obtains from the second CN node 152, e.g., the NRF, the requested IMS media function candidates operating at distances closest to the geographical location of the UPF node 140. The IMS media function candidates may e.g., be comprised in a list of IMS media function candidates. The obtained IMS media function candidates may e.g., comprise information indicating their respective id, a site id indicating which site they are located in, and additional already specified parameters for NRF responses e.g., capacity, load etc.

Action 505. The IMS control node 130 then selects IMS media functions 160 for the IMS call session based on their respective distance to the geographical location of the selected UPF node 140. The IMS media functions 160 are selected among the IMS media function candidates. The IMS media functions 160 that are selected may not always be the closest one of the candidates, this is since other parameters such as load and capacity may be considered when deciding which IMS media functions 160 to select. However, the IMS media functions 160 are selected among the closest ones.

In this way the IMS control node 130 has selected IMS media functions that are close to the UPF node 140, to lowering the distance between the UPF node 140 and the IMS media functions. Thereby the latency has been improved, this is since the contribution of distance has been eliminated which is impacting the total latency. Further, the UE 120 user experience has been improved, this is since the total latency is lowered for the latency sensitive services such as e.g., AR.

The selected IMS media functions 160 may e.g., comprise any one or more out of: an Access Gateway (AGW), a Data Channel Media Function (DCMF), and an Augmented Reality Media Function (ARMF).

FIG. 6 shows exemplary embodiments of a method performed by the second CN node 152. The second CN node 152 may be represented by an NRF node. The method is for determining IMS media function candidates, such as e.g., AGW, DCMF, ARMF, to an IMS call session for the UE 120 in the wireless communications network 100.

The method comprises the following actions, which actions may be taken in any suitable order. Optional actions are referred to as dashed boxes in FIG. 6.

Action 601. In some embodiments, the second CN node 152 receives from IMS media functions 160 information about their respective geographical locations.

The IMS media functions 160 may register to the second CN node 152 and indicate about their respective geographical location.

Action 602. The second CN node 152 obtains correlations. The correlations relate to geographical locations between the IMS media functions 160 and UPF nodes 140 regarding their mutual distances.

The second CN node 152 may perform IMS media functions 160 and UPF node 140 geographical location, also referred to as area, mapping. This may be performed by configuration and local data in the NRF.

According to an example scenario the UE 120 is about to set up an IMS call session e.g. for AR telephony for sending and/or receiving IMS media, such as e.g., any one or more out of audio, video and AR media. Or as an alternative update of the IMS call session with new IMS media.

Action 603. This action may be performed during IMS call session set up for the UE 120 or later during update of the session with new media.

The second CN node 152 receives information and a request from the IMS control node 130. The information is about the UPF node 140 and its geographical location. The UPF node 140 is serving the UE 120. The request requests IMS media function candidates operating at distances closest to the geographical location of the UPF node 140.

According to the example scenario, as mentioned above, the second CN node 152 has knowledge about the geographical location of different IMS media functions. The second CN node 152 has received information from the IMS node 130 about the geographical location of the UPF node 140 that is serving the UE 120. The second CN node 152 is asked to and will use this information to find IMS media function candidates that are close to the geographical location of the UPF node 140.

The IMS control node 130 may e.g., comprise any one or more out of an S-CSCF node, a P-CSCF, and an IMS AS node.

Action 604. Also, this action may be performed during IMS call session set up for the UE 120 or later during update of the session with new media.

The second CN node 152 determines IMS media function candidates according to the request, based on the obtained correlations and the received information. This may e.g., be performed by local configuration.

The determined IMS media functions 160 may comprise any one or more out of an AGW, a DCMF, and an ARMF.

Action 605. Also, this action is performed during IMS call session set up for the UE 120. The second CN node 152 sends to the IMS control node 130 the determined IMS media function candidates. In this way the second CN node 152 assists the IMS control node 130 in selecting IMS media functions that are close to the UPF node 140, to lowering the distance between the UPF node 140 and the IMS media functions. Thereby the latency and the UE 120 user experience have been improved.

Embodiments herein such as the embodiments mentioned above will now be further described and exemplified. The text below is applicable to and may be combined with any suitable embodiment described above.

Some actions 701-707 of the method according to an example scenario of embodiments herein is shown in the sequence diagram depicted in FIG. 7.

Action 701. This relates to and may be combined with Action 602 as described above. The second CN node 132 such as the NRF node obtains UPF site identifications (id)s and IMS site ids as well as their correlation, also referred to as mapping, in terms of vicinity to each other. The second CN node 132 may further map IMS media functions with UPF nodes, such as e.g., the UPF node 140 based on geographical (geo) location.

Action 702. This relates to and may be combined with Action 601 as described above. The IMS Media plane NFs 160 registers to the second CN node 132 such as the NRF node and indicates their own geographical area and/or site id etc.

It should be noted that the actions 701 and 702 may be taken in any suitable order.

Action 703. The UE sets up IMS PDU session towards the first CN node 151, such as the SMF whereby an UPF such as the UPF node 140 is selected for the UE 120, and obtains connectivity for IMS services. Further the UE 120 performs and IMS Registration towards the IMS control node 130 such as e.g., towards the P-CSCF and further to S-CSCF and is being authenticated on IMS layer towards HSS.

Action 704. The IMS control node 130 such as the S-CSCF node and/or the P-CSCF node requests and obtains the selected UPF node's 140 geo location. This relates to and may be combined with Actions 501 and 502 as described above.

According to a first option 1, Action 704a, the IMS control node 130 is represented by a P-CSCF node and the first CN node 151 is represented by an SMF node. In this option 2, the P-CSCF retrieves the requested UPF node's 140 geographical location via the PCF node. The information may be stored in P-CSCF. The P-CSCF node may include information about the UPF nodes e.g., in P-Access-Network-Information (PANI) header: upd-site: “xxxxxx”. The information may be stored in S-CSCF.

According to a second option 2, Action 704b, the IMS control node 130 is represented by the S-CSCF node and the first CN node 151 is represented by the SMF, node. In this option 2, the S-CSCF node retrieves the requested UPF node's 140 geographical location via the HSS. The S-CSCF node may include the UPF node 140 site id and/or geo area in a Session Initiation Protocol (SIP) Register 200 in a new SIP header or in a parameter in existing SIP header

Action 705 (Not shown). The UPF 140 geographical location also referred to as geo area, is propagated e.g. in SIP, e.g., in PANI with a new parameter e.g., upf-area: “<geo-area identity>”.

Action 706. This relates to and may be combined with Action 503, 504, 603, 604 and 605 as described above. The second CN node 152, such as the NRF node, receives a request from the IMS control node 130 and determines IMS media function candidates 160 close to the UPF node 140. The second CN node 152 then sends the IMS media function candidates 160 to the IMS control node 130.

Action 707, This relates to and may be combined with Action 505 as described above. The IMS control node 130 such as the IMS AS node, then selects for the IMS call session, IMS media functions 160 such as e.g. any one or more out of AGW, DCMF, and ARMF, among the IMS media function candidates, based on their respective distance to the geographical location of the selected UPF node 140. This may be performed during call setup or later during update of the session with new media.

The procedures in steps 706 or 707 are applicable to other IMS network functions e.g., IMS AS selecting a Media Resource Function (MRF).

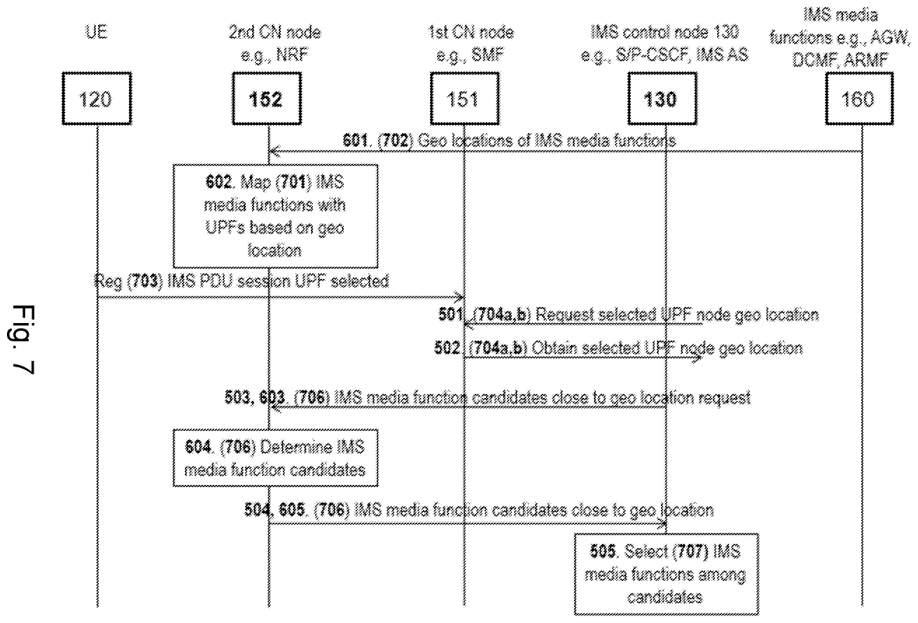

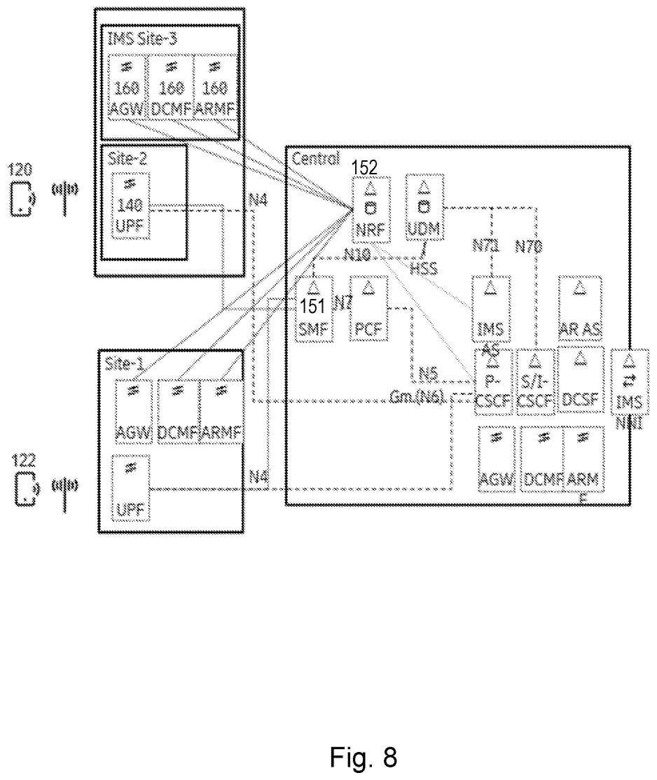

An IMS based AR telephony architecture according to an example of embodiments herein is depicted in FIG. 8. In this IMS based AR telephony architecture, an IMS user plane may be involved in transport and/or processing of IMS media, including audio, video and AR media. Three sites are shown in this example scenario. Site-1 is a site close to location of the second UE 122 with both UPF and IMS Media Functions on same site. Site-2 is a site close to the UE 120 and where Site-3 hosts IMS Media Functions closest to Site 2 with only UPF. The part referring to Central in FIG. 7 relates to 5GC and IMS Control functions as well as IMS Media Function for non-latency sensitive services.

In FIG. 7, according to an example scenario of embodiments herein, for the UE 122, the IMS media plane NFs such as e.g., AGW, DCMF and ARMF in site 1 would be selected while for the UE 120, close to UPF site-2, IMS NFs 160 in a close IMS site will be selected, i.e., IMS site-3. The distance between Site-1 or Site-2 to Central Site may be saved for processing that would need to be performed by ARMF for the UE in question.

A general densification of the wireless communications network 100 may be a generic need. This is to aid good latency KPIs for heavy processing AR use cases, when offloaded to the wireless communications network 100 may be assumed herein, which.

A VoNR device and/or VoLTE device, such as e.g., the UE 120, and an extension of such devices with AR, may setup an IMS PDU session which will be used for IMS based services. This follows existing principles defined in 3GPP GSMA PRD NG.114 and for 4G, 3GPP GSMA PRD IR.92.

It may further be assumed that the UPF serving the IMS PDU session is selected optimally, i.e., close to UE's current location based on existing procedures in 3GPP.

Some parts of embodiments may e.g. comprise following:
Propagation of UPF geographical site to IMS during IMS registration. This may be based on new procedures as described above, either
The IMS control node 130 being an P-CSCF and requesting such information via new procedures from PCF (N5) and PCF requesting it further from SMF (over N7) or.
The IMS control node 130 being an S-CSCF during IMS Registration and authentication additionally request for this information over N70 from HSS, where HSS retrieves this information from a UDM. The information may need to be stored in UDM or retrieved by UDM from SMF. The S-CSCF would then need to provide it to the P-CSCF in SIP signaling during IMS Registration procedure in 200 OK response to SIP Register.
The IMS media plane NFs registration to second CN node 152 such as the NRF node with their geographical site.
The IMS control plane NFs selecting media plane e.g., The IMS control node 130 such as e.g., P-CSCF, IMS AS etc. during a session setup or when new media is added, by the second CN node 152, such as the NRF node, query to get the set of applicable IMS media plane NFs considering the received UPF node 140 geographical area, also referred to as location.
Returned candidates from the second CN node 152 such as the NRF node may be selected either those IMS media function in same site as the UPF node 140 or those in a close IMS site. The vicinity, also referred to as close to, of sites for the UPF node 140 and the IMS media plane may be provisioned in the second CN node 152 such as the NRF node.

To perform the method actions above, the IMS control node 130 is configured to select IMS media functions 160 associated to an IMS call session for the UE 120 in the wireless communications network 100.

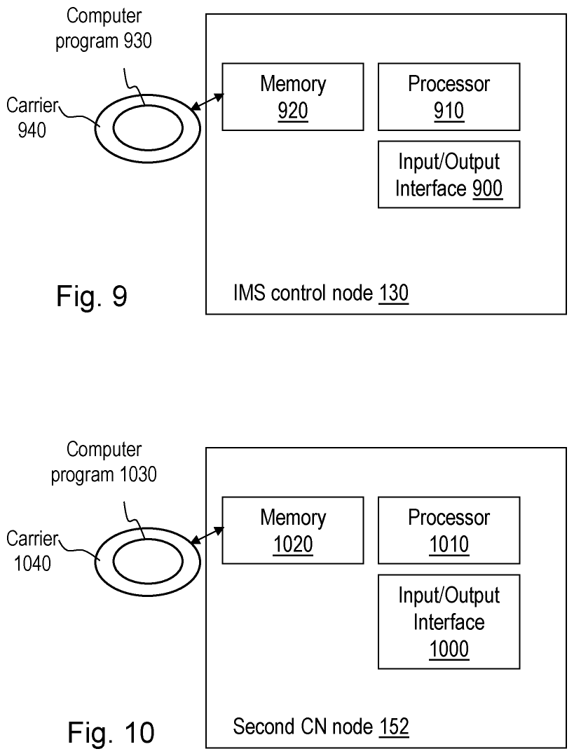

The IMS control node 130 may comprise an arrangement depicted in FIG. 9. The IMS control node 130 may comprise an input and output interface 900 configured to communicate in the wireless communications network 100, e.g., with the UE 120, the first CN node 111, the second CN node 152 and the base station. The input and output interface 900 may comprise a wireless receiver not shown, and a wireless transmitter not shown.

The IMS control node 130 is further configured to, e.g. during IMS registration for the UE 120, request and obtain from the first CN node 151, information about the UPF node 140 and its geographical location. The UPF node 140 is adapted to serve the UE 120.

The IMS control node 130 is further configured to e.g., during IMS call session set up for the UE 120, request and obtain from a second CN node 152, IMS media function candidates operating at distances closest to the geographical location of the UPF node 140, and

The IMS control node 130 is further configured to select for the IMS call session, IMS media functions 160 among the IMS media function candidates, based on their respective distance to the geographical location of the selected UPF node 140.

In some embodiments, the IMS control node 130 is adapted to be represented by a P-CSCF node and the first CN node 151 is adapted to be represented by a SMF node. In these embodiments, the IMS control node 130 is further configured to request and obtain from the first CN node 151, information about the UPF node 140 and its geographical location by: requesting and obtaining from the SMF node via a Policy Control Function, PCF, node, the information about the geographical location of the UPF node 140.

In some other embodiments, the IMS control node 130 is adapted to be represented by a S-CSCF node and the first CN node 151 is adapted to be represented by an SMF node. In these other embodiments, the IMS control node 130 is further configured to request and obtain from the first CN node 151, information about the UPF node 140 and its geographical location by: requesting and obtaining from the SMF node via an HSS node, the information about the geographical location of the UPF node 140.

The selected IMS media functions 160 may be adapted to comprise any one or more out of: an AGW, a DCMF, and an ARMF.

The IMS control node 130 may be adapted to be represented by any one or more out of: a P-CSCF node, an S-CSCF node, and an IMS A, node.

The first CN node 151 may be adapted to be represented by an SMF node, and/or the second CN node 152 may be adapted to be represented by an NRF node.

To perform the method actions above, second CN node 152 is configured to determine IMS media function candidates to an IMS call session for the UE 120 in the wireless communications network 100.

The second CN node 152 may comprise an arrangement depicted in FIG. 10. The second CN node 152 may comprise an input and output interface 1000 configured to communicate in the wireless communications network 100, e.g., with any of the IMS control node 130, and the base station 110. The input and output interface 1000 may comprise a wireless receiver not shown, and a wireless transmitter not shown.

The second CN node 152 is further is configured to obtain correlations. The correlations are adapted to relate to geographical locations between the IMS media functions 160 and UPF nodes 140, regarding their mutual distances.
e.g., during IMS call session set up for the UE 120:

The second CN node 152 is further is configured to receive information and a request from an IMS control node 130. The information is adapted to be about the UPF node 140, and its geographical location. The UPF node 140 is serving the UE 120. The request is adapted to request IMS media function candidates operating at distances closest to the geographical location of the UPF node 140.

The second CN node 152 is further is configured to determine IMS media function candidates according to the request, based on the obtained correlations and the received information send the determined IMS media function candidates to the IMS control node 130.

The second CN node 152 may further being configured to receive from IMS media functions 160, information about their respective geographical locations.

The determined IMS media function candidates 160 may be adapted to comprise any one or more out of: an AGW, a DCMF, and an ARMF.

The IMS control node 130 is adapted to be represented by any one or more out of: a P-CSCF node, an S-CSCF node, and an IMS AS node.

The second CN node 152 may be adapted to be represented by an NRF node.

Embodiments herein may be implemented through a respective processor or one or more processors, such as the respective processor 910 of a processing circuitry in the IMS control node 130 depicted in FIG. 9, and processor 1010 of a processing circuitry in the second CN node 152 depicted in FIG. 10 together with respective computer program code for performing the functions and actions of the embodiments herein. The program code mentioned above may also be provided as a computer program product, for instance in the form of a data carrier carrying computer program code for performing the embodiments herein when being loaded into the respective network node 130 and UE 120. One such carrier may be in the form of a CD ROM disc. It is however feasible with other data carriers such as a memory stick. The computer program code may furthermore be provided as pure program code on a server and downloaded to the IMS control node 130 and the second CN node 152.

The IMS control node 130 and the second CN node 152 may further comprise a respective memory 920 and memory 1020 comprising one or more memory units. The respective memory 920 and memory 1020 comprises instructions executable by the processor in the respective IMS control node 130 and second CN node 152. The respective memory 920 and memory 1020 are arranged to be used to store e.g., geographical locations of the UPF node 140 and the IMS media functions, the IMS media function candidates, rating criteria, energy rating parameters, information, indications, data, configurations, communication data, and applications to perform the methods herein when being executed in the respective IMS control node 130 and second CN node 152.

In some embodiments, a respective computer program 930 and computer program 1030 comprises instructions, which when executed by the respective at least one processor 910 and processor 1010, cause the at least one processor of respective IMS control node 130 and second CN node 152 to perform the actions above.

In some embodiments, a respective carrier 940 and carrier 1040 comprises the respective computer program 930 and computer program 1030, wherein the respective carrier 940 and carrier 1040 is one of an electronic signal, an optical signal, an electromagnetic signal, a magnetic signal, an electric signal, a radio signal, a microwave signal, or a computer-readable storage medium.

Those skilled in the art will appreciate that units in the respective IMS control node 130 and second CN node 152 described above may refer to a combination of analog and digital circuits, and/or one or more processors configured with software and/or firmware, e.g. stored in the respective IMS control node 130 and second CN node 152, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

### Additional Explanation

Some of the embodiments contemplated herein will now be described more fully with reference to the accompanying drawings. Embodiments are provided by way of example to convey the scope of the subject matter to those skilled in the art.

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs 120, 122, QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

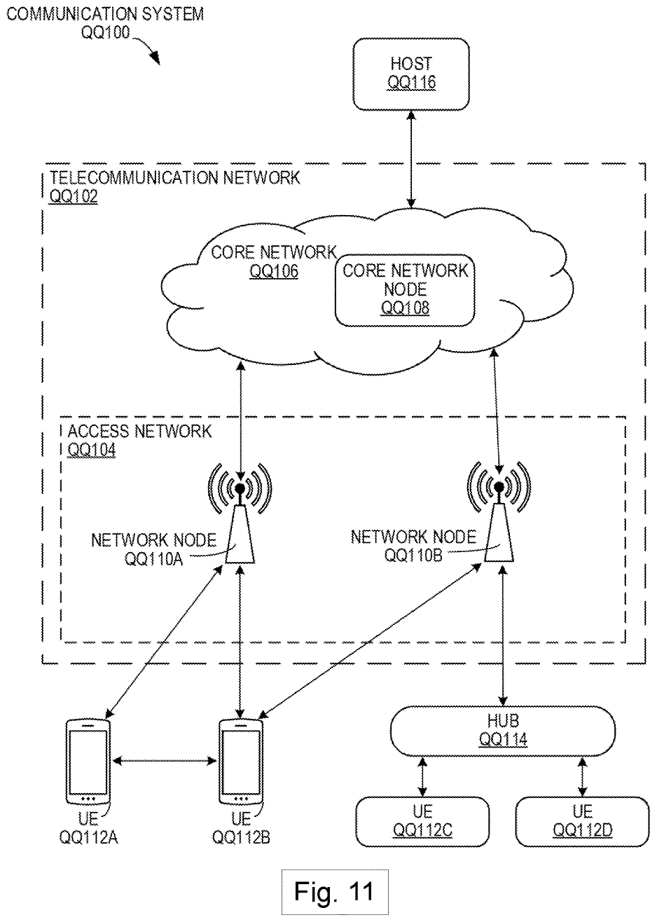

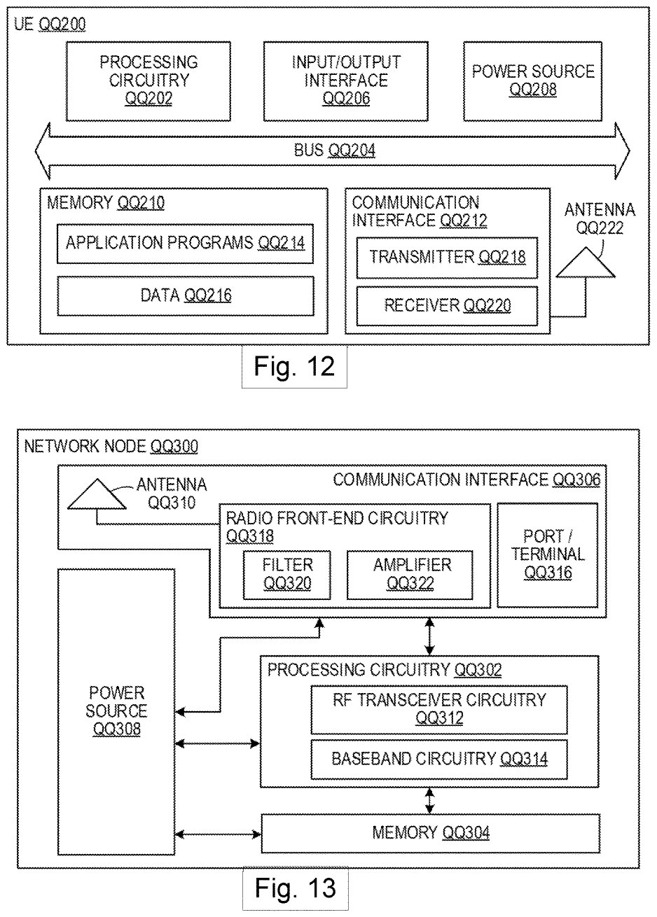

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

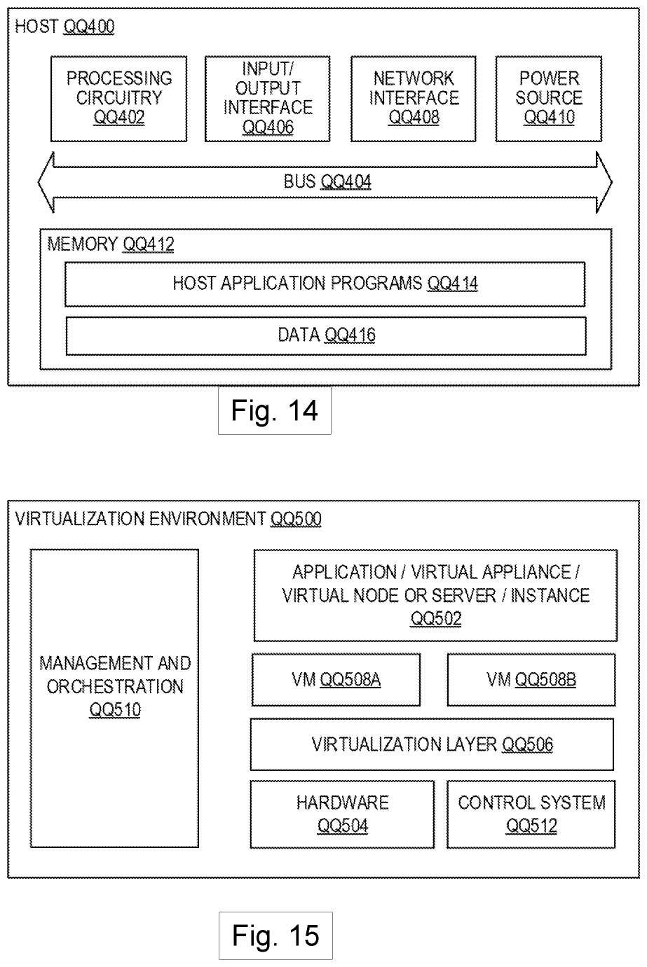

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

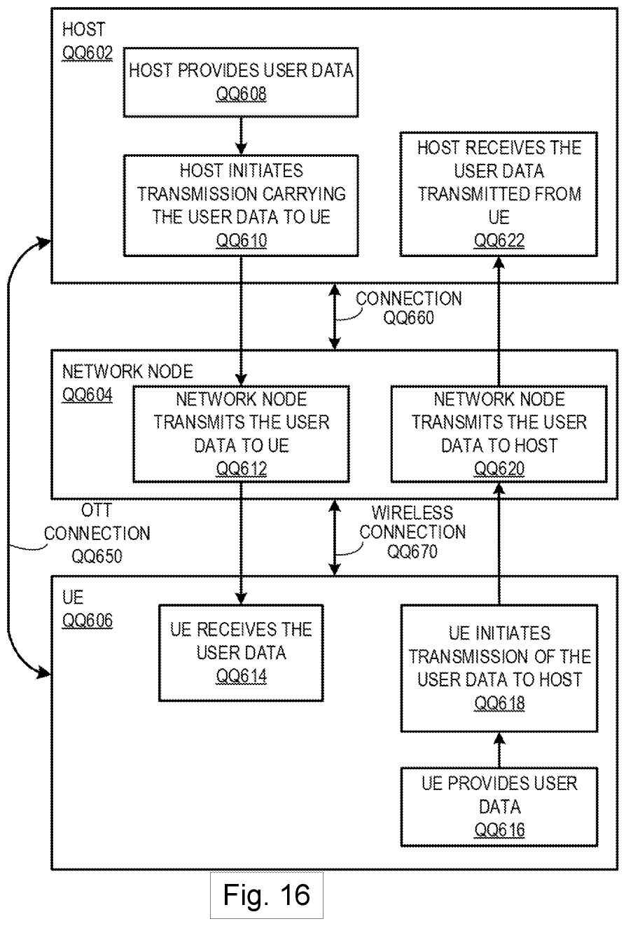

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the latency and thereby provide benefits such as reduced user waiting time.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by an Internet Protocol Multimedia Subsystem, IMS, control node (130) for selecting IMS media functions (160) associated to an IMS call session for a User Equipment, UE, (120) in a wireless communications network (100), the method comprising:
during IMS registration for the UE (120), requesting (501) and obtaining (502) from a first Core Network, CN, node (151) information about a User Plane Function, UPF, node (140) and its geographical location, which UPF node (140) is serving the UE (120),
requesting (503) and obtaining (504) from a second CN node (152), IMS media function candidates operating at distances closest to the geographical location of the UPF node (140), and
selecting (505) for the IMS call session, IMS media functions (160) among the IMS media function candidates, based on their respective distance to the geographical location of the selected UPF node (140).

2. The method according to claim 1, wherein the IMS control node (130) is represented by a Proxy Call Session Control Function, P-CSCF, node and the first CN node (151) is represented by a System Management Facility, SMF, node,
and wherein the requesting (501) and obtaining (502) from the first CN node (151), information about the UPF node (140) and its geographical location comprises:
requesting (501) and obtaining (502) from the SMF node via a Policy Control Function, PCF, node, the information about the geographical location of the UPF node (140).

3. The method according to claim 1, (4b) wherein the IMS control node (130) is represented by a Serving Call Session Control Function, S-CSCF, node and the first CN node (151) is represented by a System Management Facility, SMF, node,
and wherein the requesting (501) and obtaining (502) from the first CN node (151) the information about the UPF node (140) and its geographical location comprises:
requesting (501) and obtaining (502) from the SMF node via a Home Subscriber Server, HSS node, information about the geographical location of the UPF node (140).

4. The method according to any of the claims 1-3, wherein the selected IMS media functions (160) comprise any one or more out of:
an Access Gateway, AGW,
a Data Channel Media Function, DCMF, and
an Augmented Reality Media Function, ARMF.

5. The method according to any of the claims 1-4, wherein the IMS control node (130) is represented by any one or more out of:
a Proxy Call Session Control Function, P-CSCF, node
a Serving Call Session Control Function, S-CSCF, node, and
an IMS Application Server, AS, node.

6. The method according to any of the claims 1-5, wherein any one or more out of:
the first CN node (151) is represented by a System Management Facility, SMF, node, and
the second CN node (152) is represented by a Network Repository Function NRF node.

7. A computer program (930) comprising instructions, which when executed by a processor (910), causes the processor (910) to perform actions according to any of the claims 1-6.

8. A carrier (940) comprising the computer program (930) of claim 7, wherein the carrier (940) is one of an electronic signal, an optical signal, an electromagnetic signal, a magnetic signal, an electric signal, a radio signal, a microwave signal, or a computer-readable storage medium.

9. A method performed by a second Core Network, CN, node (152) for determining Internet Protocol Multimedia Subsystem, IMS, media function candidates to an IMS call session for a User Equipment, UE, (120) in a wireless communications network (100), the method comprising:
obtaining (602) correlations, which correlations relate to geographical locations between the IMS media functions (160) and UPF nodes (140), regarding their mutual distances,
receiving (603) information and a request from an IMS control node (130), which information is about a User Plane Function, UPF, node (140), and its geographical location, which UPF node (140) is serving the UE (120), and which request requests IMS media function candidates operating at distances closest to the geographical location of the UPF node (140),
determining (604) IMS media function candidates according to the request, based on the obtained correlations and the received information, and
sending (605) to the IMS control node (130), the determined IMS media function candidates.

10. The method according to claims 9, further comprising:
receiving (601) from IMS media functions (160), information about their respective geographical locations.

11. The method according to any of the claims 9-10, wherein the determined IMS media function candidates (160) comprise any one or more out of:
an Access Gateway, AGW,
a Data Channel Media Function, DCMF, and
an Augmented Reality Media Function, ARMF.

12. The method according to any of the claims 9-11, wherein the IMS control node (130) is represented by any one or more out of:
a Proxy Call Session Control Function, P-CSCF, node
a Serving Call Session Control Function, S-CSCF, node, and
an IMS Application Server, AS, node.

13. The method according to any of the claims 9-12, wherein the second CN node (152) is represented by a Network Repository Function NRF node.

14. A computer program (1030) comprising instructions, which when executed by a processor (1010), causes the processor (1010) to perform actions according to any of the claims 9-13.

15. A carrier (1040) comprising the computer program (1030) of claim 14, wherein the carrier (1040) is one of an electronic signal, an optical signal, an electromagnetic signal, a magnetic signal, an electric signal, a radio signal, a microwave signal, or a computer-readable storage medium.

16. An Internet Protocol Multimedia Subsystem, IMS, control node (130) configured to select IMS media functions (160) associated to an IMS call session for a User Equipment, UE, (120) in a wireless communications network (100), the IMS control node (130) further being configured to:
during IMS registration for the UE (120), request and obtain from a first Core Network, CN, node (151) information about a User Plane Function, UPF, node (140) and its geographical location, which UPF node (140) is adapted to serve the UE (120),
request and obtain from a second CN node (152), IMS media function candidates operating at distances closest to the geographical location of the UPF node (140), and
select for the IMS call session, IMS media functions (160) among the IMS media function candidates, based on their respective distance to the geographical location of the selected UPF node (140).

17. The IMS control node (130) according to claim 16, wherein the IMS control node (130) is adapted to be represented by a Proxy Call Session Control Function, P-CSCF, node and the first CN node (151) is adapted to be represented by a System Management Facility, SMF, node, and wherein the IMS control node (130) further is configured to:
request and obtain from the first CN node (151), information about the UPF node (140) and its geographical location by:
requesting and obtaining from the SMF node via a Policy Control Function, PCF, node, the information about the geographical location of the UPF node (140).

18. The IMS control node (130) according to claim 16, wherein the IMS control node (130) is adapted to be represented by a Serving Call Session Control Function, S-CSCF, node and the first CN node (151) is adapted to be represented by a System Management Facility, SMF, node, and wherein the IMS control node (130) further is configured to:
request and obtain from the first CN node (151), information about the UPF node (140) and its geographical location by:
requesting and obtaining from the SMF node via a Home Subscriber Server, HSS node, the information about the geographical location of the UPF node (140).

19. The IMS control node (130) according to any of the claims 16-18, wherein the selected IMS media functions (160) is adapted to comprise any one or more out of:
an Access Gateway, AGW,
a Data Channel Media Function, DCMF, and
an Augmented Reality Media Function, ARMF.

20. The IMS control node (130) according to any of the claims 16-19, wherein the IMS control node (130) is adapted to be represented by any one or more out of:
a Proxy Call Session Control Function, P-CSCF, node
a Serving Call Session Control Function, S-CSCF, node, and
an IMS Application Server, AS, node.

21. The IMS control node (130) according to any of the claims 16-20, wherein any one or more out of:
the first CN node (151) is adapted to be represented by a System Management Facility, SMF, node, and
the second CN node (152) is adapted to be represented by a Network Repository Function NRF node.

22. A second Core Network, CN, node (152) configured to determine Internet Protocol Multimedia Subsystem, IMS, media function candidates to an IMS call session for a User Equipment, UE, (120) in a wireless communications network (100), wherein the second CN node (152) further is configured to:
obtain correlations, which correlations are adapted to relate to geographical locations between the IMS media functions (160) and UPF nodes (140), regarding their mutual distances,
receive information and a request from an IMS control node (130), which information is adapted to be about a User Plane Function, UPF, node (140), and its geographical location, which UPF node (140) is serving the UE (120), and which request is adapted to request IMS media function candidates operating at distances closest to the geographical location of the UPF node (140),
determine IMS media function candidates according to the request, based on the obtained correlations and the received information, and
send the determined IMS media function candidates to the IMS control node (130).

23. The second CN node (152) according to claims 22, further being configured to:
receive from IMS media functions (160), information about their respective geographical locations.

24. The second CN node (152) according to any of the claims 22-23, wherein the determined IMS media function candidates (160) are adapted to comprise any one or more out of:
an Access Gateway, AGW,
a Data Channel Media Function, DCMF, and
an Augmented Reality Media Function, ARMF.

25. The second CN node (152) according to any of the claims 22-24, wherein the IMS control node (130) is adapted to be represented by any one or more out of:
a Proxy Call Session Control Function, P-CSCF, node
a Serving Call Session Control Function, S-CSCF, node, and
an IMS Application Server, AS, node.

26. The second CN node (152) according to any of the claims 22-25, wherein the second CN node (152) is adapted to be represented by a Network Repository Function NRF node.
